(19) United States
(12) Patent Application Publication
(10) Pub. No.: US 2008/0238950 A1
(43) Pub. Date: Oct. 2, 2008

(54) Illuminating display and weighted-bit driving methods for use with the same

(75) Inventor: Yavuz S. Saglam, Sussex, WI (US)

Correspondence Address: FOLEY & LARDNER LLP, 777 EAST WISCONSIN AVENUE, MILWAUKEE, WI, 53202-5306, US

(73) Assignee: Adaptive Micro Systems, LLC

(21) Appl. No.: 11/732,134

(22) Filed: Apr. 2, 2007

(51) Int. Cl. G09G 3/32; G09G 5/10

(52) U.S. Cl. 345/690; 345/83

(57) ABSTRACT

A method for driving the output of a illuminating display is provided. The method includes providing a display panel having a plurality of pixels, wherein each pixel includes at least one diode color. A display controller is also provided that is configured to process video data numbers for display. The method further includes loading a bit of a video data number into a diode driver, sending an output enabling state to the diode driver such that a diode will turn on if the bit of the video data number in the diode driver is enabled while an output enabling signal is activated, maintaining the output enabling signal for a period of time, wherein the period of time is based on a bit position of the bit of the video data number loaded in the diode driver, and repeating the loading, sending, and maintaining steps until all bits of the video data number have been loaded.

### BACKGROUND

The application generally relates to controllers and methods of controlling light emitting diode displays. The application relates more specifically to color driving circuits and color correction methods for light emitting diode displays.

Illuminating displays have been used for many years to convey information, provide lighting, and/or to entertain observers. While conventional illuminating displays were typically static arrangements of incandescent or fluorescent lamps, more recent illuminating displays are dynamic (e.g., animated, information-changing, etc.) or programmed and/or typically use different illuminating technology. One such technology that has increasingly been used with illuminating displays is light emitting diode (“LED”) technology. Displays or signs having LEDs often provide certain benefits over fluorescent or incandescent lamps. These benefits may include efficiency benefits, higher image resolution possibilities, decreased service requirements, increased programmability, and longer sign lifespan. Today LEDs are used in displays, signs or boards of just about every type, size, or shape and in just about every context (e.g., highway signs, traffic lights and signals, exit signs, message displays at transportation hubs, billboards, live-motion stadium screens, casino signs, building signs, etc.).

An LED is a generally a chip of semi-conducting material configured to emit electroluminescent light. The natural color or brightness of an LED depends on the chemical composition and condition of the semi-conducting material. LED signs typically use a relatively large number of LEDs arranged in an orderly or unorderly fashion. Manufacturing impurities may result in the need to identify batches of LEDs having similar natural color or brightness characteristics. For a variety of reasons ranging from aesthetic to practical (e.g., sign readability, etc.), it is desirable for a sign to be able to produce consistent and uniform observable color and brightness levels. If LEDs having substantially different characteristics are used, inconsistent observable color and brightness levels may result. One conventional way of solving this problem involves large-scale inventory testing and sorting by the LED supplier or sign manufacturer. This type of sorting may result in inefficient production times and/or require undesirably large LED inventory levels. This problem is compounded when a large sign having many arrays of individual LEDs must be produced. If a display includes an array of sub-panels a “tiling effect” can result because of diode characteristic differences between sub-panels.

Some devices and methods have been developed to address these problems. In particular, controllers may be designed and/or programmed to help correct color and/or brightness inconsistencies as the LEDs are being displayed. One way to address this problem involves color or brightness correction methods such that some LEDs of a sign are switched on and/or off for a longer or shorter time during a video frame than other LEDs. This time difference may be predetermined to correct for a set of LEDs' color or brightness characteristics versus a measured reference. Some of these color or brightness correction methods may rapidly consider and continually compare correction timing data (representing how long or how often per frame time to enable an LED or set of LEDs) to a clock or counter for each LED in a sign. These methods may require the use of at least one counter per pixel. Not only do these methods require a relatively large number of logic parts to implement, but they may be complicated to manufacture. These methods may require larger, faster, and/or more expensive controlling processors or circuitry than are desirable. These methods may also typically result in a large number of data transfer tasks that may further cause electromagnetic interference issues. These electromagnetic interference issues may yet further negatively affect the quality of important clock signals used to drive the sign video and/or color correction circuitry.

It would be desirable to provide a color or brightness correction method for LED displays that reduces the number of correction-related data transfers. It would further be desirable to provide a correction method for LED displays that reduces dynamic loading of display components and electromagnetic interference levels. It would further be desirable to provide a correction method that requires fewer logic device resources. It would further be desirable to provide a correction method that increases correction accuracy. It would further be desirable to provide a correction method that reduces dependency on clock signals and counting operations. It would further be desirable to provide a correction method that may be used with relatively lower clock frequencies or lead to cleaner clock signals. It would further be desirable to provide signs, LED panels, and/or controllers having one or more of the aforementioned advantageous methods or advantages.

What is needed is a system and/or method that satisfies one or more of these needs or provides other advantageous features. Other features and advantages will be made apparent from the present specification. The teachings disclosed extend to those embodiments that fall within the scope of the claims, regardless of whether they accomplish one or more of the aforementioned needs.

### SUMMARY

One embodiment relates to a method for driving the output of a illuminating display. The method includes providing a display panel having a plurality of pixels, wherein each pixel includes at least one diode color. A display controller is also provided that is configured to process video data numbers for display. The method further includes loading a bit of a video data number into a diode driver, sending an output enabling state to the diode driver such that a diode will turn on if the bit of the video data number in the diode driver is enabled while an output enabling signal is activated, maintaining the output enabling signal for a period of time, wherein the period of time is based on a bit position of the bit of the video data number loaded in the diode driver, and repeating the loading, sending, and maintaining steps until all bits of the video data number have been loaded.

Another embodiment relates to an illuminating display. The illuminating display includes a display panel having a plurality of light emitting diodes. The illuminating display also includes a controller configured to process input video data, the controller being further configured to enable a light emitting diode of the display panel if the input video data indicates that the light emitting diode should be enabled or disabled during a display time, the display time being a fixed period of time during which output may be sent from the controller to the diode. A color driver component is functionally integrated with the controller. The color driver component is configured to sequentially considers bits of a binary video data number to adjust a duration of time during the display time that the light emitting diodes are enabled or disabled, and the bit positions of the video data number are time weighted so that each bit represents a different amount of time to adjust the duration of time.

Another embodiment relates to an illuminating display. The illuminating display includes a plurality of display panels, each display panel having a plurality of pixels arranged in rows and columns, each pixel containing at least two diodes of different diode-colors, and the diodes of like diode-colors on any given display panel are matched to have very close color characteristics. The illuminating display also includes a controller associated with each display panel, each controller being configured to process input video data such that video data for each row of the display panel is sequentially output and refreshed, each row having one row on time per refresh. The illuminating display also includes a color driving component for each diode-color of each display panel, the color driving component being functionally integrated with the controller. The color driving component is configured to sequentially consider the bit positions of video data numbers to adjust how long the light emitting diodes of a diode-color are enabled during each row on time, and the bit positions of the video data numbers are weighted such that each bit represents a different amount of adjustment time.

Another embodiment relates to a method for adjusting the amount of time the bits of a video data number are displayed by a diode driver of a multiplexing RGB LED display panel to correct for LED intensity and color characteristics. The method includes loading a brightness level number for each row on time of the multiplexing RGB LED display panel. The method further includes sequentially displaying each bit of a video data number at an LED during the row on time. The method yet further includes controlling the amount of time each bit of the video data number is displayed by counting until the magnitude of the brightness level number has been reached, and dividing the brightness level number by two for each bit position after the most significant bit position of the video data number.

Alternative exemplary embodiments relate to other features and combinations of features as may be generally recited in the claims.

### BRIEF DESCRIPTION OF THE FIGURES

The application will become more fully understood from the following detailed description, taken in conjunction with the accompanying figures, wherein like reference numerals refer to like elements, in which:

FIG. 1 is a perspective view of an illuminating display having an array of display panels, according to an exemplary embodiment;

FIG. 2A is a close-up perspective view of a display panel of an illuminating display, according to an exemplary embodiment;

FIG. 2B is a close-up perspective view of a display panel, according to an exemplary embodiment;

FIG. 3A is a perspective view of a display panel pixel board, according to an exemplary embodiment;

FIG. 3B is a front view of a display panel pixel board, according to an exemplary embodiment;

FIG. 3C is a top view of a display panel pixel board, according to an exemplary embodiment;

FIG. 4A is a block diagram view of a display pixel having three light emitting diodes of different colors, according to an exemplary embodiment;

FIG. 4B is an exemplary chromaticity diagram used to grade diode colors of a display panel and to create brightness level numbers, according to an exemplary embodiment;

FIG. 5 is a timing diagram of a constantly-shifting color driving or correction method, according to an alternative method of controllably driving LED colors of an illuminating display;

FIG. 6 is a block diagram of a display panel controller, according to an exemplary embodiment;

FIG. 7 is a flow chart of general display panel display operation that the display panel controller shown in FIG. 6 might control, according to an exemplary embodiment;

FIG. 8 is a timing diagram illustrating pulse width modulation count versus row on time, according to an exemplary embodiment;

FIG. 9A is a timing diagram of a weighted-bit method, according to an exemplary embodiment;

FIG. 9B is a timing diagram for an exemplary video data number and brightness level number, showing the weighted-bit method's effect on a controlled diode color;

FIG. 10 is a block diagram of a color driving circuit or component, according to an exemplary embodiment;

FIG. 11 is a flow chart of a weighted-bit method that a color driving circuit and display panel controller that FIGS. 10 and 6 might control, according to an exemplary embodiment.

FIG. 12 is generalized flow chart of the weighted-bit driving method, according to an exemplary embodiment.

### DETAILED DESCRIPTION OF THE EXEMPLARY EMBODIMENTS

Before turning to the figures which illustrate the exemplary embodiments in detail, it should be understood that the application is not limited to the details or methodology set forth in the following description or illustrated in the figures. It should also be understood that the phraseology and terminology employed herein is for the purpose of description only and should not be regarded as limiting.

Referring generally to the figures, an illuminating display is shown. An illuminating display may have a plurality of display panels. Each panel may have a plurality of light emitting pixels. Each light emitting pixel may include a plurality of colored LEDs, the LEDs being of different diode colors. Controllers may be provided to drive the pixels of the display such that different stored or streamed video data may be displayed on the display. Because LEDs frequently do not generate pure colors, a display panel controller may need to conduct a color space conversion activity to convert raw input video data to converted video data based on the diode colors of the display panel pixels. For example, if raw video data represents a pure red to be displayed to observers, a display panel controller may determine that Red, Green, and Blue diode colors must each be enabled at some intensity to display the pure red color to an observer. Because color and intensity characteristics can vary from diode to diode, taking yet further steps beyond basic color space conversion activity may provide increased control over the observable display output. To address diode color and brightness level inconsistencies within specific display panels, each display panel is produced with diodes having very close color characteristics. To avoid brightness level or color inconsistencies between display panels of the illuminating display which could cause a tiling effect, a display panel controller includes a color driving component or circuit for each diode color of each display panel. For example, a display panel may include three color driving circuits when there are three different diode colors for each pixel. After the display panel controller has conducted color space conversion, the color driving components may read a brightness level number from calibration memory for each diode color of the display panel. A brightness level number is based on the actual measured or graded characteristics of a display panel diode color versus target observable color and brightness values. The display panel controller and color driving components in particular, may generally utilize a weighted-bit driving method to controllably vary diode color intensity and to display uniform observable colors. A weighted bit driving method of a color driving component sequentially steps through bits of video data, using bit states and bit positions to determine how long the light emitting diodes controlled by that color driving component are to be enabled during a row on time to obtain a target observable color. The length of time the diodes are enabled during a row on time is further reduced or adjusted based on the brightness level number read from calibration memory. Weighted-bit video data driving, supplemented by brightness level adjustments and display panel diode color matching, may result in consistent observable color and brightness levels between display panels of an illuminating display while reducing the amount of data pulsed from controllers to diode drivers per row on time.

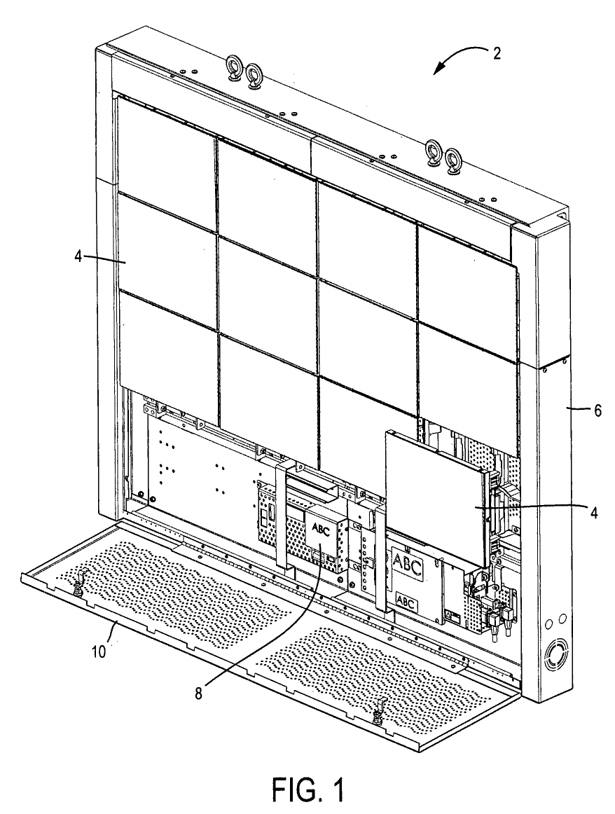

Referring to FIG. 1, a perspective view of an illuminating display 2 having a plurality of display panels 4 is shown, according to an exemplary embodiment. Illuminating display 2 may further include a display housing 6, a video distributor 8, and an electronics access panel 10. Display housing 6 may take any form (e.g., rectangular, circular, etc.) and may include an array of display panels 4 of any number or configuration. Display housing 6 may made of any material or a variety of materials suitable for housing LED electronics. Display 2, for example, has metal display housing 6 and a display panel array of four display panels 4 wide by three display panels high. Video distributor 8 (i.e., display driver board) generally stores, receives, and/or coordinates video data (e.g., via wireless communications, wired communications, etc.) for a plurality of display panels 4 and provides video signals to individual display panels 4 of display 2. Additional display electronics, wiring, cooling, structural features and/or other hardware or software features may also be included in display 2 that are not shown in FIG. 1 or the remaining figures. For example, a power input mechanism or power supply mechanism are not shown in detail but will likely be included with any illuminating display 2.

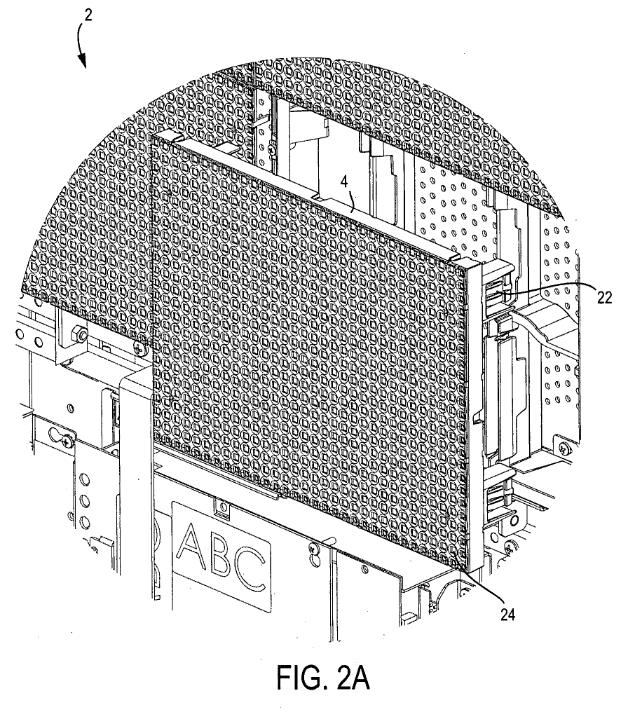

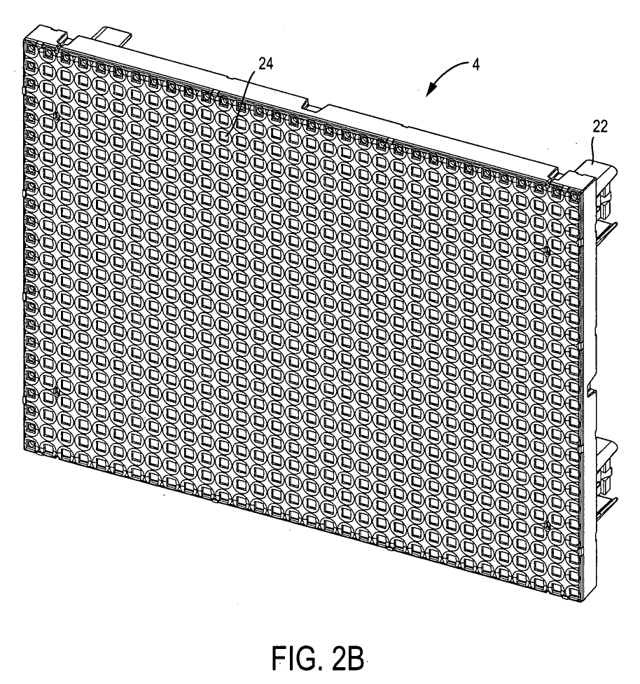

Referring to FIGS. 2A and 2B, close-up perspective views of a display panel 4 of an illuminating display 2 are shown, according to an exemplary embodiment. Each display panel 4 may generally include display pixel locations 24 and display panel housing interfaces 22. Display panel pixel locations 24 are shown distributed on display panel 4 in a uniform or linear manner, the pixel locations arranged in vertical and horizontal rows and columns. According to various alternative embodiments, display panel pixel locations may be spaced differently, arranged differently, and/or shaped differently. Display panel housing interfaces 22 may generally be configured to fixably attach each display panel 4 to display 2. Display panel housing interfaces 22 may be of any suitable type (e.g., snap-fit, bolted, screwed, adhered, etc.). According to various alternative embodiments, display panels may be integrally formed on a large display, and the display panels may be logical/electrical “panels.” According to yet further exemplary embodiments, each physical display panel may include a plurality of logical display panels.

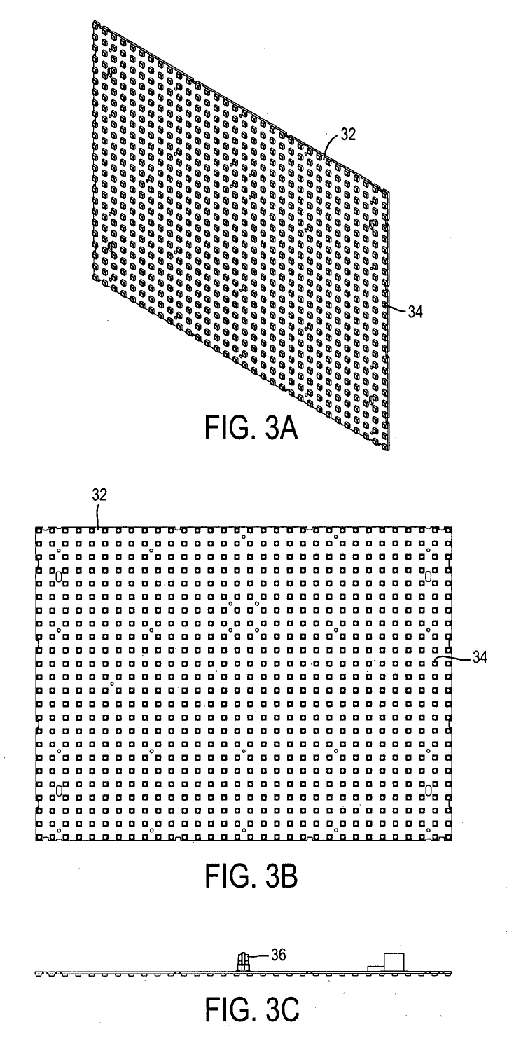

Referring to FIGS. 3A-3C, a display panel pixel board 32 is generally shown, according to an exemplary embodiment. FIG. 3A is a perspective view of display panel pixel board 32. FIG. 3B is a front view of display panel pixel board 32, according to an exemplary embodiment. FIG. 3C is a top view of display panel pixel board 32, according to an exemplary embodiment. Pixel board 32 may generally be a mounting board or printed circuit board having a plurality of pixels 34. Pixel board 32 may have a variety of interfaces for structurally connecting or coupling pixel board 32 to other structures of display panel 4 and/or display 2 shown in the previous FIGS. Pixel board 32 may also have any variety of electronic interfaces 36 for controllably or electronically coupling pixel board 32 to display control mechanisms, adjacent display panels, and/or other video distribution or power components.

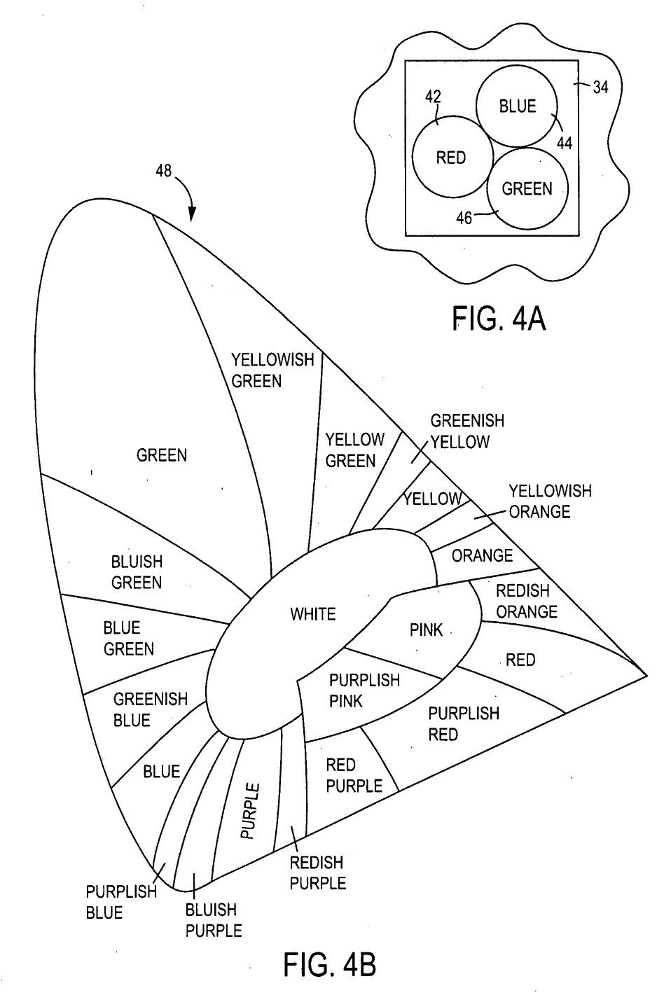

Referring to FIG. 4A, a block diagram of a display pixel 34 having three light emitting diodes is shown, according to an exemplary embodiment. Each pixel of a display panel may include one or more light emitting diodes. If light emitting diodes of different diode colors are used, a greater number of observable color combinations may be obtained by controlling the relative intensities of the plurality of LEDs within any given pixel 34. Pixel 34 shown by way of example in FIG. 4A includes three diodes, a red diode 42, a blue diode 44, and a green diode 46. The output intensity of these three diodes may be controlled to create a variety of colors. According to various alternative embodiments, more than one diode for each diode color may be included in a pixel. For example, four red diodes, three green diodes, and five blue diodes may be included in a pixel.

Referring to FIG. 4B, a typical chromaticity diagram is shown. While diodes 42, 44, and 46 correspond with three primary colors, a large number of observable pixel colors may be obtained by controllably varying the relative intensities of the diodes of any given pixel. During the manufacturing process of a an illuminating display, diodes of like diode-colors are sorted or “binned” based on their color and intensity characteristics. For each diode color of a display panel, diodes with very similar characteristics (i.e., diodes from a single or similar bin) are installed onto a display panel of an illuminating display. Display panels may then be graded by a grader or otherwise measured and a brightness level number for each diode color may be determined and stored in a calibration memory of a display panel controller. The brightness level numbers may be determined so that when a white color is signaled to all display panels of a display, each display panel displays the same observable white point with the same intensity. Brightness level numbers of any given display panel are dictated by the LEDs used on the display panel. For example, if a display panel included a particularly bright set of red diodes and a particularly weak set of blue diodes, the brightness level number associated with the red diodes of that display panel might be constructed to dim the red diodes significantly such that the combination of the red, green, and blue diodes can reach the target white point. The chromaticity diagram shown in FIG. 4B may be an International Commission on Illumination color space chromaticity diagram such as the “CIE 1931” chromaticity diagram. This diagram, or at least related teachings, data, and/or calculations may be used throughout the manufacture, programming, and operation of an illuminating display of the present application. For example, the diagram may be used during the binning process, grading process (e.g., brightness level number generation, etc.), and/or color space conversion process.

Referring generally to FIGS. 1-4B, illuminating display 2 is driven via a multiplexed driving method, according to an exemplary embodiment. Display panels 4 of illuminating display 2 are daisy-chained. Each display panel is associated with (or includes) a controller that receives display-wide video data through a signal interface. The controller generally receives and processes the video frame data. During processing, the video frame data is generally moved to a video buffer by LED column, and then moves the data out of the video frame buffer one LED row at a time. This type of driving is generally referred to as multiplexed driving. As the data is shifted and all the rows of a display panel are turned on in sequence, a complete video frame is displayed. According to various other exemplary embodiments, multiplexed driving could occur by shifting video frame data into an LED row first, and then sequentially turning complete columns of row data on and off. An illuminating display that utilizes a multiplexed driving method and red, green, and blue (“RGB”) diode colors may generally be referred to as a multiplexed RGB display.

Because LED chromaticity characteristics are non-linear (e.g., it might be easier to display a green observable color than a red observable color) and because individual LED color characteristics may deviate from a reference, some amount of fine control over LED color generation and correction is desirable when using multiplexed LED displays.

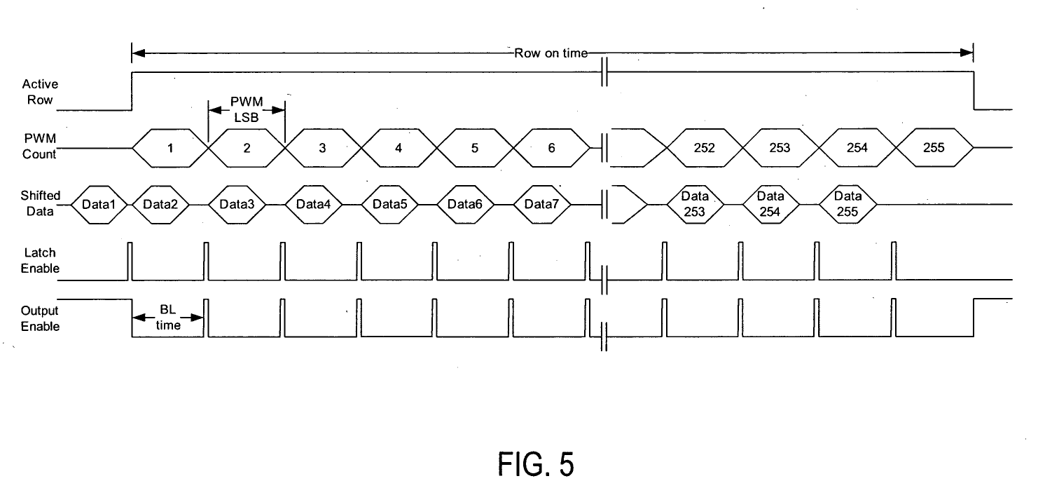

Referring to FIG. 5, a timing diagram of a constantly-shifting color generation method, is shown. A constantly-shifting color generation method is an alternative method to the weighted bit method of the present application. A display panel implementing a constantly-shifting color generation method may use one 8-bit counter per led per pixel to conduct color correction. Video data to be displayed for a particular diode color is loaded into the 8-bit counter and counted down every time a pulse width modulation counter advances. The value of the 8-bit counter is compared to some predetermined correction value, and if the count is greater than the static correction value, a logical one is generated. This one-bit is shifted through the column drivers and the column drivers may display the present video data. For example, if a constantly-shifting color generation method loads a data value of “100” corresponding to a target color, one-bit diode enabling data will be shifted 100 times (out of 255 total counts per row time) to the column driver. During the remaining time (155 counts) a zero will be shifted to the column drivers and the diode will not display the data. A complete row on time (255 pulse-width modulation “PWM” counts) will complete a row scan. Using such a constantly-shifting color generation method, three 8-bit counters per pixel, one counter per LED color of a pixel, are required and data must be shifted up to 255 times per row on time. This constantly-shifting color generation method may result in many of the challenges mentioned in the Background section of the present application.

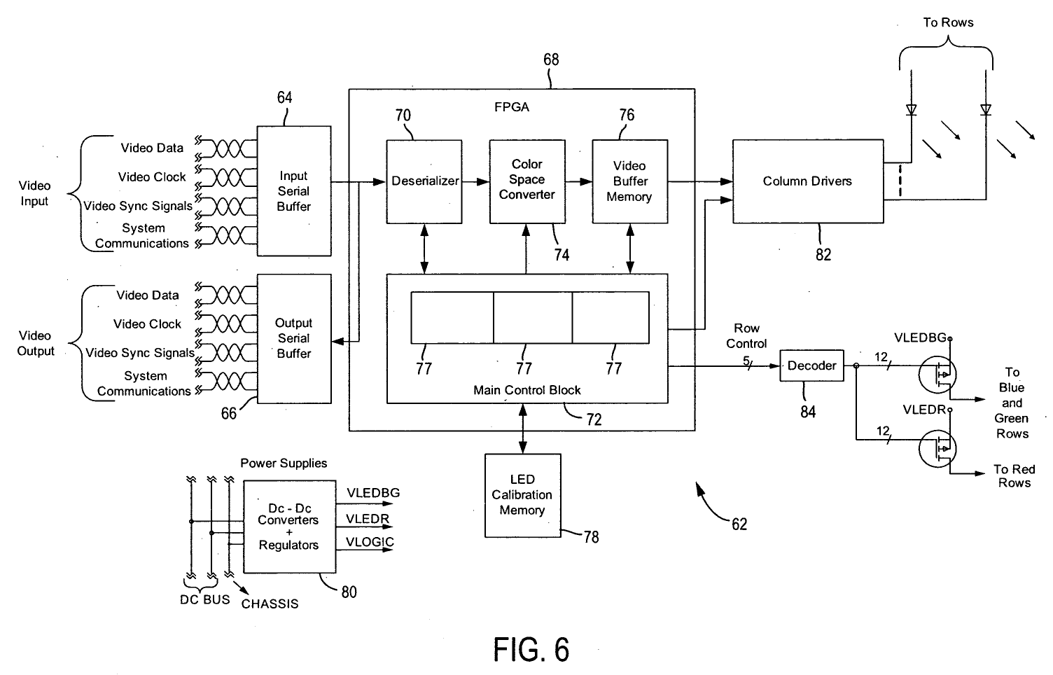

Referring to FIG. 6, a block diagram of a display panel controller 62, configured to implement a weighted-bit color driving method is shown, according to an exemplary embodiment. Display panel controller 62 receives video input through an interface such as a differential serial interface. Video input signals may include video clock, video data, video synchronization pulses, and other system communications data. This data may be buffered via buffering circuitry such as input serial buffer 64, and single-ended signals may be obtained from the balanced signal input lines. These signals may then be regenerated and fed back through output serial buffer 66 so that the signals may be used in driving the next display panel within the display panel chain. For example, display panels 4 are connected to video distributor 8 (previously shown) in series. Video distributor 8 may send video clock data, video data, and video synchronization pulses through a signal interface to a first display panel 4, the first display panel may read the data then forward it to the next display panel, and so on. According to various alternative embodiments, video distributor 8 may distribute video signals to display panels 4 in parallel or via some serial/parallel mix.

Video data may initially be serialized video data carrying 24-bits per pixel information that is synchronized with the video clock signal. Using 8-bits per diode color with a driving scheme of 8-bit pulse width modulation (“PWM”), a board of an exemplary embodiment may generate up to 16.7 million colors. Video synchronization pulses may also be in serialized form and are generally synchronized with the video clock such that the pulse edges of the video synchronization signal and video clock signal have substantially similar timing.

A field-programmable gate array (“FPGA”) 68 may be provided and programmed to conduct each display panel's primary video data and color processing tasks. FPGA 68 may include a deserializer 70, a main control block 72, a color space converter 74, and a video buffer memory 76. Deserializer 70 may deserialize both the video data and the video synchronization pulses to obtain their parallel form. The parallel form of the video data is forwarded to color space converter 74 and main control block 72. Under the supervision of the main control block, the video data is processed by color space converter 74. According to an exemplary embodiment, one color space converter 74 exists for each display panel. Once color space converter 74 and main control block 72 have processed the video data it is placed into video buffer memory 76.

Color space converter 74 is configured to receive raw video data from deserializer 70. Raw video data may point to specific colors (e.g., “red: 255, green: 0, blue: 0”), in binary. However, to display a target color on a display panel, some color space conversion or video data transformation may need to be done depending on the general characteristics of the diodes used to create the display panel. For example, to display a target red on an LED display, it may be necessary to turn on some green and blue content (e.g., red: 230, green: 55, blue: 30). Color space converter 74 may accomplish this color space conversion my multiplying the input video data by a display color conversion matrix based on target white colors per a chromaticity chart such as the chart shown in FIG. 4B and diode characteristics of the illuminating display. According to various alternative embodiments, the color space converter may conduct any number of alternative or additional color space conversion activities of the past, present, or future that may generally adapt raw input video data to the general characteristics of the diodes of the illuminating display.

Referring still to FIG. 6, display panel controller 62 may also include a power supply 80 or any number of power supply components. These components may include connections to a direct current bus of the display, grounds to chassis, direct-current to direct-current converters and regulators, etc. Power supply 80 may also provide voltage sources to the pixels and diodes. For example, power supply 80 may include a voltage source for red diodes, a voltage source for blue and green diodes, a voltage source for other logic components, etc. According to various exemplary embodiments, any suitable power supply design or components of the past, present, or future may be provided to drive the illuminating display panels.

Referring yet further to FIG. 6, display panel controller 62 may also include or send output to column drivers 82 and row control decoder 84. Column drivers 82 load column data for an entire row, including column data that has been corrected by color correction component 74. When fully loaded, and after the previous row has been scanned, column drivers may be commanded to display a display panel row of pixels and/or diodes. Row control decoder 84 may provide the row scanning or row enabling triggering of display panel controller 62. The amount of time a row of LEDs can be driven per row scan may be characterized as the “row on time.”

Referring further to FIG. 6, main control block 72 may include three similar color driving components 77, according to an exemplary embodiment. One color driving component 77 may be provided per display pixel diode color. Color driving component 77 may use a weighted-bit driving method to control the timing and output intensity of the diode color that color driving component 77 is responsible for driving. This weighted-bit activity allows color to be driven using a reduced amount of controller to column driver (i.e., diode driver) data transfer activity compared to a constantly-shifting driving method and may allow further adjustments of diode color output intensity to correct for diode color characteristics of the display panel. Color driving component 77 may output, among other signals, a control signal, a clock signal, an output enable signal, and a latch enable signal to column drivers 82. The weighted-bit driving method of color driving component 77 generally sequentially considers a video data number and also considers a brightness level read from calibration memory 78 to controllably activate or deactivate an output enable pin of column drivers 82. In this manner, the weighted-bit driving method sequentially controls the amount of time each bit of a video data number at the column drivers is enabled during a row time.

Referring yet further to FIG. 6, the brightness level numbers that are considered by color driving components 77 are stored within LED calibration memory 78, according to an exemplary embodiment. LED calibration memory 78 contains a brightness level number for each diode color wherein the brightness level numbers have been programmed during display panel manufacturing, testing, or programming such that the color driving process is able to obtain a target white point according to a chromaticity chart such as the chromaticity chart shown in FIG. 4B. As all display panels and their accompanying controllers draw on brightness level numbers for each diode color of the display panel, potential tiling effects that may result from using display panels having diode sets of different color and/or brightness characteristics may be minimized or reduced.

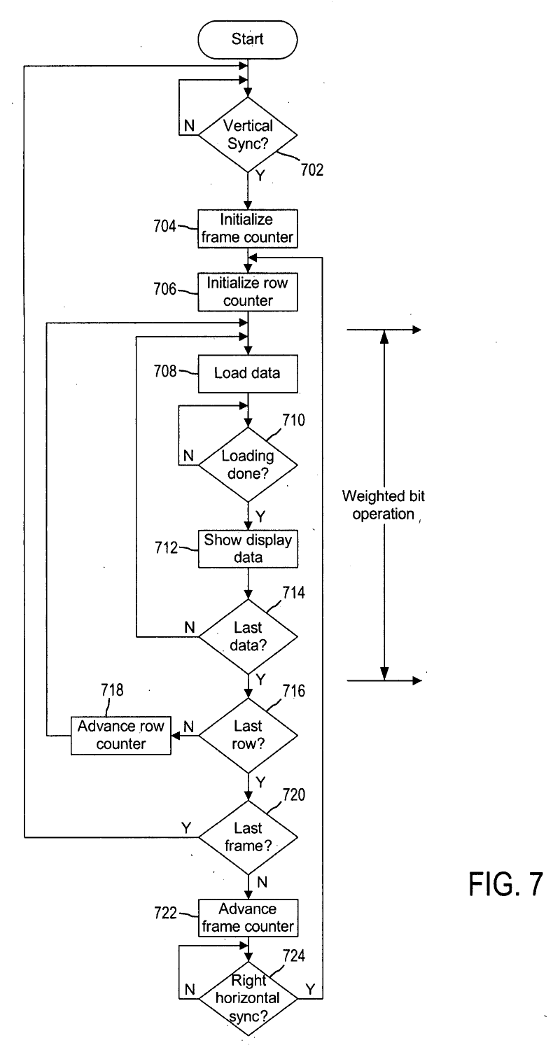

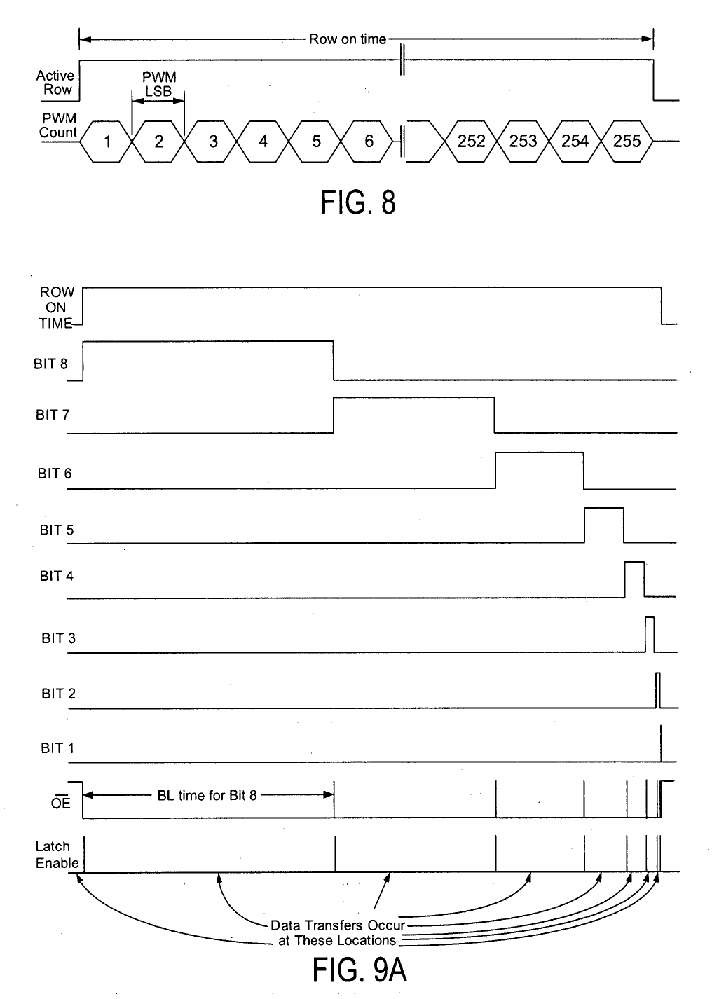

Referring to FIG. 7, the general method which display panel controller 62 may use to display video data is shown, according to an exemplary embodiment. Display panel controller 62 is synchronized to video synchronization pulses. These synchronization pulses may be generated at a central video synchronization pulse generator (e.g., in video distributor 8 shown in FIG. 8) or by various other interconnected and/or distributed oscillators or clocks that may provide synchronization to display panel controllers 62 of display panels 4. According to an exemplary embodiment, every display panel controller 62 is synchronized based on the video synchronization pulses such that the process shown in FIG. 7 is run for each display panel in approximately the same amount of time. Display panel controller 62 may begin one display process cycle by checking to determine whether a vertical synchronization pulse has arrived (step 702). If a vertical synchronization pulse has not arrived the controller may enter a loop until a vertical synchronization pulse does arrive. When a vertical synchronization pulse arrives, the controller initializes a frame counter (step 704). Every incoming video frame is displayed four times, but could be scanned or displayed more or less times depending on the application. The frame counter counts the number of frames that have been displayed. At the beginning of each frame, a row counter will be initialized (step 706). Video data is loaded into the column drivers (step 708). Loading video data into the column drivers includes sequentially loading bits of processed video data from a video buffer into a column driver. The controller checks to determine whether or not loading has completed (step 710) and continues checking until loading is complete. Once loading is complete, the row driver corresponding to the loaded data is pulsed on such that the loaded data for one row is displayed (step 712). A check is then run to determine whether or not the last processed video data bit has been displayed (step 714). If the last processed video data bit has not been displayed, the process loops back to the load data step (step 708), and the next bit is loaded and displayed. When the last processed video data bit has been displayed, the controller may then check to determine whether the last row has been displayed (step 716). If the last row has not been displayed, a row counter advances (step 718) and another row of data is sequentially loaded and displayed. When the last row of a frame has been displayed, the controller checks to determine whether or not the last frame (e.g., of four) has been displayed (step 720). If the last frame has been displayed, the controller is ready for a new video frame, the process repeats, and the controller again waits for another vertical synchronization pulse (step 702). If the last frame has not been reached, the frame counter is advanced (step 722) and the controller waits for a correct horizontal synchronization pulse (or correct horizontal synchronization pulse count) to arrive (step 724). As FIG. 7 indicates, during the video data display process, a weighted-bit operation is running in parallel to the process shown in FIG. 7 to generate and correct displayed color levels by changing or pulsing how long the video data displayed in step 712 is displayed during a row on time.

Referring to FIG. 8, a timing diagram illustrating a total amount of row on time a row is displayed before the next row is displayed is shown. A PWM counter divides the row on time into 255 equal time slices. To obtain a specific observable color, diodes are pulsed on an off during a controlled portion of row time. This time-controlled pulsing more specifically adjusts the output intensity of the diodes of a pixel such that a specific combined observable pixel color is output during a row time. Each of the 255 equal time slices is further divided into 255 sub-slices or sub-counts to allow for yet further output intensity adjustment.

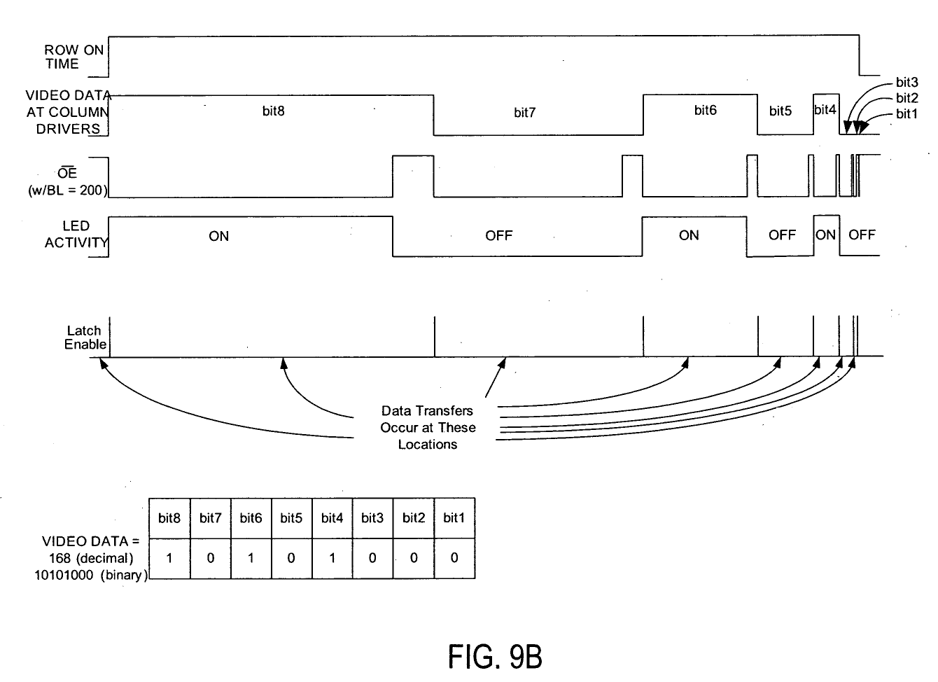

Referring to FIG. 9A, a timing diagram of a weighted-bit driving method is shown, according to an exemplary embodiment. The weighted-bit driving method generally loads a predetermined brightness level number for a display panel diode color and considers video data number bits sequentially. A brightness level number is a number that provides information about how long a diode color of a display panel should be driven to adjust for the unique characteristics of the LEDs of the diode color. Color driving component 74 (shown in FIG. 6) uses the brightness level number (“BL”) to weight the timing of the bits of video data at column drivers 82 (BIT 8-1 of FIG. 9A) by controlling an output enable signal (“ O̅E̅”) sent to the column drivers. If the output enable signal is held active for a relatively long time during a row on time, an LED will look brighter. If the output enable signal is held active for a relatively short time during a row on time, an LED will look dimmer. The accurate representation of this time is possible, according to one exemplary embodiment, if the 255 PWM counts of a row on time are further divided into 255 sub-slices. As a result of this division, the whole row on time is sliced into 255×255 equal slices. So, for example, if 200 is the brightness level number, BIT 8 of the video data should stay on for 128×200 counts (128 corresponding to the bit position of the video data being considered and 200 corresponding to the brightness level number). Bit 7 should stay on for 64×200 counts (bit position, brightness level number), etc.

Referring to FIGS. 9A and 9B, an example of the output enabling timing activity of the color driving component is shown, according to an exemplary embodiment. For any total row on time, 8 bits of video data at the column drivers may be considered. The state of each bit of the video data determines whether the diode will be enabled during a corresponding bit time. For example, in FIG. 9B, video data bits 8, 6, and 4 are in an enabled state (e.g., 1), so these the diodes will be enabled for some period of time during bit times 8, 6, and 4, respectively. The total possible bit enabled time of each bit position is weighted by the color driving component. For example, bit 8's total possible bit enabled time is 128 of 255 row on time counts. Each subsequent total possible bit enabled time is halved (e.g., bit 6's total possible bit enabled time is 32 of 255 row on time counts, etc.). In other words, bit 8, the most significant bit, may be enabled for one half of the row on time. The remaining bits (i.e., BITS 7-1) must share the remaining one half row time. Each subsequent bit's total possible bit enabled time will equal one half the remaining row on time.

The portion of each total possible bit time a diodes is enabled is controlled by the magnitude of the brightness level number. The example of FIG. 9B uses a brightness level number of 200 (binary “1100 1000”) and a video data number of 168 (binary “1010 1000”). Because the brightness level number (“BL”) is 200, the total possible bit time for bit 8 (128 of 255 row on time counts) will be reduced by a factor of (200/255). So, for video data bit 8 an output enable signal (inverted or not) is sent to the column drivers such that the LED is “ON” for a time of 128×200 out of a total possible time of 128×255. An LED is “OFF” for video data bit 7 because video data bit 7 is not enabled. Video data bit 6 is enabled, but bit 6 is weighted by the color driving component such that the total possible bit enabled time for bit 6 is 32×255. This total time is reduced by the BL number of 200, however, to result in an output enable signal and subsequent LED “ON” count of 32×200.

LED “ON” and “OFF” times for FIG. 9B may be summarized as follows:
Video BIT 8=LED “ON” a time of (128×200) of row on time total (255×255);

### Video BIT 7==LED “OFF”;

Video BIT 6=LED “ON” a time of (32×200) of row on time total (255×255);

### Video BIT 5==LED “OFF”;

Video BIT 4=LED “ON” a time of (8×200) of row on time total (255×255);

### Video BIT 3=LED “OFF”;

### Video BIT 2=LED “OFF”;

### Video BIT 1==LED “OFF”.

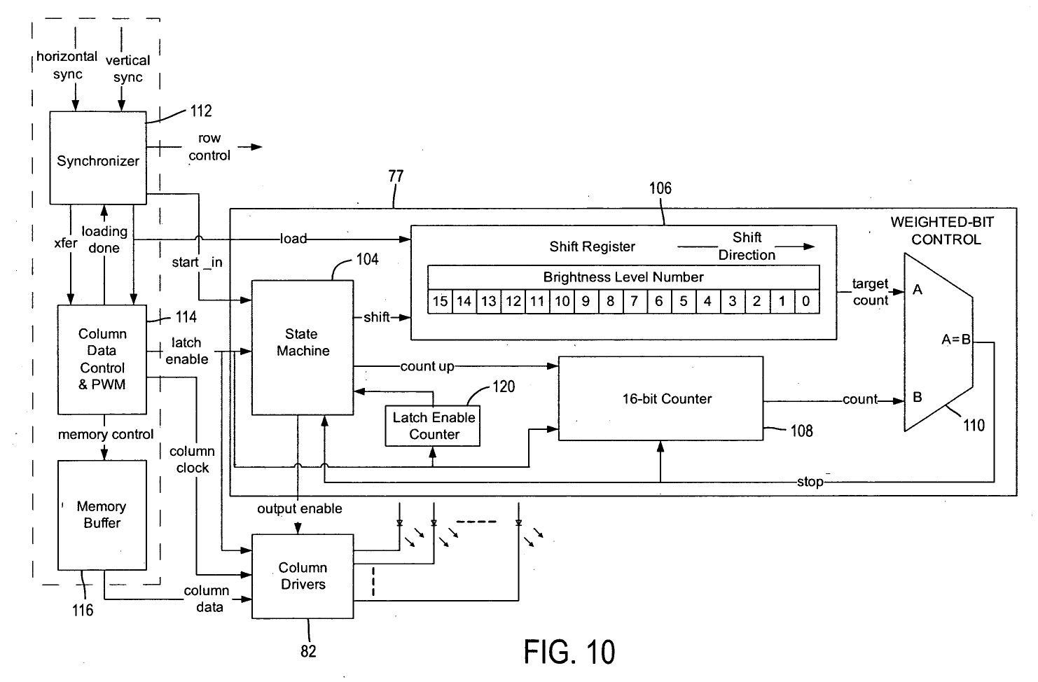

Referring to FIG. 10, a block diagram of color driving component 77 is shown, according to an exemplary embodiment. Color driving component 77 generally includes a state machine 104, a shift register 106, a counter 108 (e.g., a 16-bit counter), a comparator 110, and a latch enable counter 120. Color driving component 77 receives inputs from synchronizer 112, and column data control and PWM components 114. Column drivers 82 receive an output enable activation signal from color driving component 77.

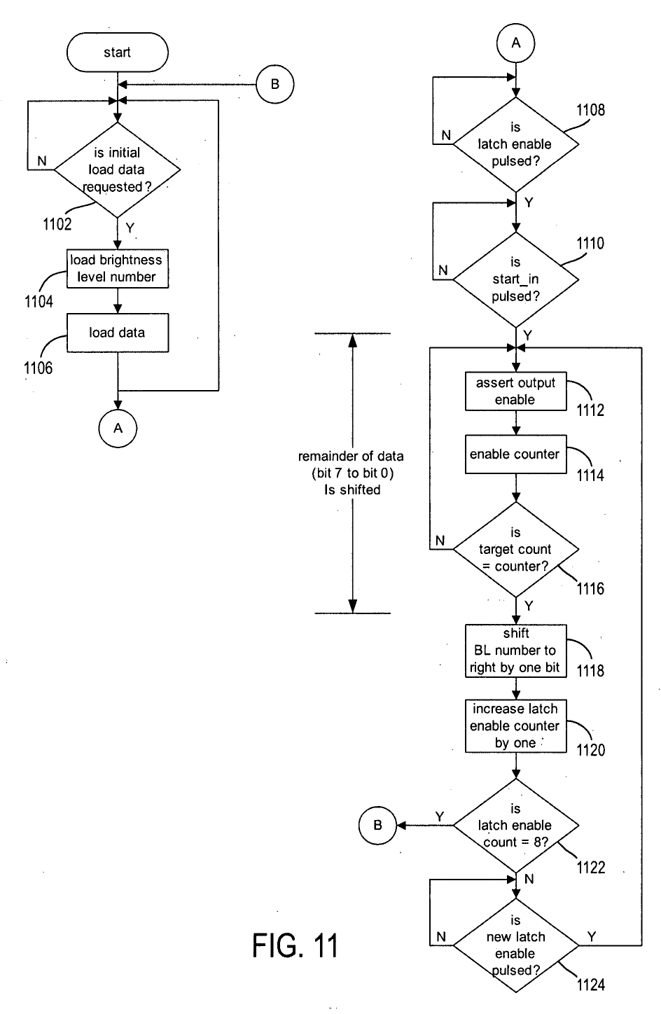

Referring to FIGS. 10 and 11, a block diagram of color driving component 77 and a flow chart of a weighted-bit method that color driving component 77 of FIG. 10 might use are shown, respectively, according to an exemplary embodiment. Color driving component 77 might first determine whether or not initial load data has been requested (step 1102). Color driving component 77 may receive this signal from the synchronizer and/or another component of the display panel controller or display video system. If initial load data has been requested, a load signal is pulsed. This pulse will trigger the loading of a brightness level number into the color driving component's shift register (step 1104). The brightness level number may be padded with zeros or stand alone, depending on the target count and the hardware used (e.g., system clock speed, etc.). The column data control and PWM components 114 may then generate control signals (e.g., latch enable, column clock, etc.) that move or load the first column video data bit (bit 8) from a memory to the column drivers 82 (step 1106). When this video data is moved, the latch enable signal is pulsed to stage machine 104 and column driver 82. State machine 104 checks for whether or not latch enable is pulsed (step 1108). If latch enable is pulsed state machine 104 will reset the outputs of the 16-bit counter to be all zeros. State machine 104 may then check to determine whether a start_in signal has been received from synchronizer 112 (step 1110). If the start_in signal is received by state machine 104, output enable is asserted (step 1112) and the 16-bit counter is enabled (step 1114). Comparator 110 will compare the target count (contents of shift register 106) to counter 108 (step 1116). The output enable and counter will remain enabled as long as the 16-bit counter is less than the target count value (the contents of shift register 106). When comparator 110 determines that the target count and counter outputs are equal, it will send a stop signal to 16-bit counter, trigger state machine 104 to command shift register 106 to shift the BL number to the right by one bit (step 1118), increase latch enable counter 120 by one (step 1120); and disable output enable. When the shift register containing a shifting BL number, a 16-bit counter, and a comparator are used in this manner, it should be apparent that the timing of each output enable assertion varies based on the magnitude of the BL number in the shift register, wherein the BL number is divided in half with each shift in the shift register. It should also be apparent that using different clocks, shift registers and/or counters would speed up or slow down the activity of color driving component 77, without departing from the basic teachings of this method.

Continuing the activity of FIGS. 10 and 11, state machine 104 checks to determine whether or not latch enable counter 120 equals “8” (step 1122). If the contents of latch enable counter 120 do not equal “8” then the next latch enable is checked and waited for (step 1124). A new latch enables arrive when the PWM counter arrives at the counts [0, 128, 192, 224, 240, 248, 252, and 254). When the new latch enable arrives, output enable is asserted again and the 16-bit counter starts to count toward the new target count. When all 8 video data bits (bits 8 to bit 1) are displayed (latch enable counter 120 equals “8”), one row of video data display is completed. These steps are repeated for all other rows to obtain a full display frame.

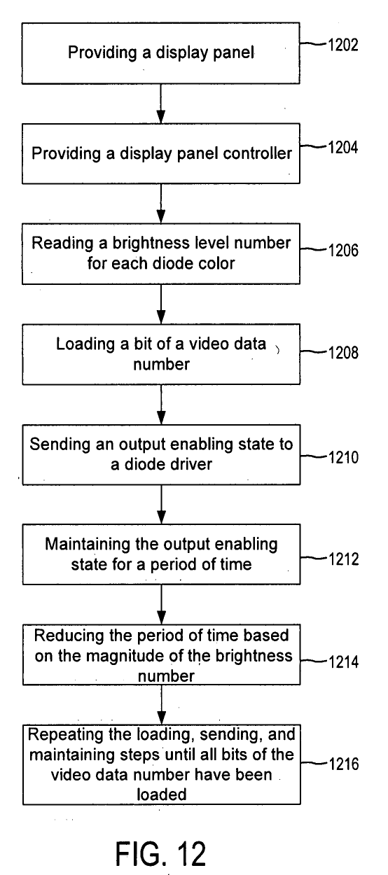

Referring to FIG. 12, a flow chart of the weighted-bit driving method is shown, according to an exemplary embodiment. A display panel (step 1202) and a multiplexing display panel controller (step 1204) may be provided. A brightness level number may be loaded (step 1206) for each diode color. A video data number bit may be loaded into a diode driver (step 1208). A color driving component may then send an output enable signal to the diode driver (step 1210) and the diode being driven will turn on if the video data number bit is enabled while the output enabling signal is activated. The color driving component will maintain the output enable signal (step 1212) for a period of time based on the bit position of the video data bit presently being displayed. The color driving component will use the BL number to determine how much each bit position of the video data bit is weighted (e.g., the color driving component will use the BL number to count for a different amount of time for each video data bit position). The color driving component will further reduce the period of time based on the magnitude of the brightness level number (step 1214). The display panel controller will repeat (step 1216) the loading, sending, and maintaining steps until all bits of the video data number have been loaded and displayed. When all bits of the video number have been loaded and displayed, a row time will be complete. A new BL number will be loaded in each color driving component and new video data numbers will be loaded into the diode drivers.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

The present application contemplates methods, systems and program products on any machine-readable media for accomplishing its operations. The embodiments of the present application may be implemented using an existing computer processors, or by a special purpose computer processor for an appropriate system, incorporated for this or another purpose or by a hardwired system.

It is important to note that the construction and arrangement of the display, display panel, pixels, controllers, and/or other components as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, different pixel structure and configuration, different numbers of diode colors per pixel, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

As noted above, embodiments within the scope of the present application include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

It should be noted that although the figures herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule based logic and other logic to accomplish the various connection steps, processing steps, comparison steps and decision steps.

What is claimed is:

1. A method for driving the output of a illuminating display, comprising:
providing a display panel having a plurality of pixels, wherein each pixel includes at least one diode color;
providing a display controller configured to process video data numbers for display;
loading a bit of a video data number into a diode driver;
sending an output enabling state to the diode driver such that a diode will turn on if the bit of the video data number in the diode driver is enabled while an output enabling signal is activated;
maintaining the output enabling signal for a period of time, wherein the period of time is based on a bit position of the bit of the video data number loaded in the diode driver; and
repeating the loading, sending, and maintaining steps until all bits of the video data number have been loaded.

2. The method of claim 1, wherein the display controller is a multiplexing display controller.

3. The method of claim 1, wherein the display controller is a multiplexing RGB display controller.

4. The method of claim 1, further comprising reading a brightness level number for each diode color.

5. The method of claim 4, wherein the period of time the output enabling signal is maintained for each video data number bit position is timed using a state of the brightness level number in a shift register compared to a counter.

6. The method of claim 4, further comprising reducing the period of time the output enabling signal is maintained by an amount based on the magnitude of the brightness level number.

7. The method of claim 1, wherein the video data number is an eight bit number.

8. The method of claim 1, wherein the sum of the maximum time each video data number bit position may be enabled is a maximum row on time per display panel scan.

9. The method of claim 8, wherein the most significant bit position of the video data number may represent a maximum output enable signal time equal to one half the maximum row on time.

10. The method of claim 9, wherein each next bit of the video data number equals one half the maximum output enable signal time of the previous bit.

11. The method of claim 4, wherein reading a brightness level number for each diode color includes loading the brightness level number into a shift register.

12. The method of claim 11, wherein the method further comprises starting a counter when the output enabling signal is first sent to a diode driver.

13. The method of claim 12, wherein the output enabling signal is maintained until the contents of the shift register equal the contents of the counter.

14. The method of claim 13, wherein the method further comprises shifting the brightness level number in the shift register to the right before repeating the loading, sending, and maintaining steps.

15. The method of claim 4, further comprising counting up to the magnitude of the brightness level number for each video data number bit position, wherein the output enabling signal is activated while the count is less than the magnitude of the brightness level number.

16. The method of claim 15, further comprising dividing the brightness level number in half for each video data bit position other than the most significant bit position of the video data number.

17. The method of claim 4, further comprising counting down to the magnitude of the brightness level number for each video data number bit position, wherein the output enabling signal is activated while the count is greater than the magnitude of the brightness level number.

18. The method of claim 17, further comprising dividing the brightness level number in half for each video data bit position other than the most significant bit position of the video data number.

19. The method of claim 1, wherein the method results in a reduced number of data transfers from display panel controllers to the diode drivers relative to a constantly-shifting method wherein data is constantly shifted with each pulse width modulation count state.

20. The method of claim 1, wherein the method results in a reduced number of output enable pulses being sent from display panel controllers to diode drivers relative to a constantly-shifting method wherein data is constantly shifted with each pulse width modulation count state.

21. The method of claim 1, wherein the method results in fewer display panel power fluctuations and a reduced amount of electromagnetic interference relative to a constantly-shifting method wherein data is constantly shifted with each pulse width modulation count state.

22. An illuminating display, comprising:
a display panel having a plurality of light emitting diodes;
a controller configured to process input video data, the controller being further configured to enable a light emitting diode of the display panel if the input video data indicates that the light emitting diode should be enabled or disabled during a display time, the display time being a fixed period of time during which output may be sent from the controller to the diode; and
a color driver component functionally integrated with the controller, wherein the color driver component is configured to sequentially considers bits of a binary video data number to adjust a duration of time during the display time that the light emitting diodes are enabled or disabled, and wherein the bit positions of the video data number are time weighted so that each bit represents a different amount of time to adjust the duration of time.

23. The method of claim 22, wherein the duration of time the LED is enabled or disabled during the display time is also based on the magnitude of a brightness level number.

24. The method of claim 23, further comprising a counter configured to count to the magnitude of the brightness level number for each bit position of the video data number.

25. The method of claim 24, wherein the color driver component is further configured to divide the brightness level number in half for each bit position of the video data number after the most significant bit position.

26. The method of claim 25, wherein the counter is reset prior to considering each bit position of the video data number such that the counter counts up from zero to the present magnitude of the brightness level number for each bit position of the video data number.

27. The method of claim 25, wherein the color driver component divides the brightness level number in half by shifting a binary representation of the brightness level number by one bit position in a shift register.

28. The method of claim 22, wherein the brightness level number is a predetermined number that exists for each diode color of the display panel.

29. The method of claim 22, wherein the brightness level number is a predetermined number that is based on the color and intensity characteristics of a set of diodes of the display panel.

30. The method of claim 26, wherein the illuminating display is a multiplexing RGB display panel.

31. An illuminating display, comprising:
a plurality of display panels, each display panel having a plurality of pixels arranged in rows and columns, each pixel containing at least two diodes of different diode-colors, wherein diodes of like diode-colors on any given display panel are matched to have very close color characteristics; a controller associated with each display panel, each controller being configured to process input video data such that video data for each row of the display panel is sequentially output and refreshed, each row having one row on time per refresh;
a color driving component for each diode-color of each display panel, the color driving component being functionally integrated with the controller, wherein the color driving component is configured to sequentially consider the bit positions of video data numbers to adjust how long the light emitting diodes of a diode-color are enabled during each row on time, and wherein the bit positions of the video data numbers are weighted such that each bit represents a different amount of adjustment time.

32. The illuminating display of claim 31, wherein the duration of time the light emitting diodes of a diode-color are enabled during each row on time is further adjusted based on a binary brightness level number associated with the diode-color.

33. The illuminating display of claim 32, wherein the binary brightness level is a predetermined number based on the actual color and brightness characteristics of its associated diode-color versus a reference color.

34. The illuminating display of claim 31, wherein the time adjusting activity of the color driving component reduces potential tiling effects of the illuminating display.

35. The illuminating display of claim 31, wherein the video data number is an eight bit number, the eighth bit position representing one half a row on time, each subsequent bit representing one half the row on time represented by the previous bit.

36. The illuminating display of claim 35, wherein the amount of time each bit position of the video data number represents is controlled by color driving component using the brightness level number.

37. The illuminating display of claim 36, wherein the color driving component counts to the magnitude of the brightness level number for each bit position of the video data number.

38. The illuminating display of claim 37, wherein the color driving component divides the brightness level number by half for each bit position of the video data number.

39. The illuminating display of claim 37, wherein the color driving component divides the brightness level number by half for each bit position of the video data number by shifting the brightness level number once in a shift register prior to beginning the counting for each bit position of the video data number other than the most significant bit position.

40. A method for adjusting the amount of time the bits of a video data number are displayed by a diode driver of a multiplexing RGB LED display panel to correct for LED intensity and color characteristics, comprising:
loading a brightness level number for each row on time of the multiplexing RGB LED display panel;
sequentially displaying each bit of a video data number at an LED during the row on time;
controlling the amount of time each bit of the video data number is displayed by counting until the magnitude of the brightness level number has been reached; and
dividing the brightness level number by two for each bit position after the most significant bit position of the video data number.
